(19) United States
(12) Patent Application Publication
(10) Pub. No.: US 2012/0012623 A1
(43) Pub. Date: Jan. 19, 2012

(54) BAND LOCK FOR A CHILD CARRYING DEVICE

(76) Inventor: Håkan Bergkvist, Bromma (SE)

(21) Appl. No.: 13/258,260

(22) PCT Filed: Apr. 15, 2010
(86) PCT No.: PCT/SE2010/050406

§ 371 Date: Sep. 27, 2011

(30) Foreign Application Priority Data
Apr. 24, 2009 (SE) 0900557-0

(51) Int. Cl. A61G 1/00; A44B 11/28

(52) U.S. Cl. 224/158; 24/598.4

(57) ABSTRACT

A band lock (1) comprising a first (2) and a second (3) part, which each comprises partly engagement portions (4, 5) for mutual detachable coupling with each other, partly band coupling portions (8, 9) for cooperation with a band (20, 21) each. The engagement portion (4) of the first part (2) comprises an engagement pin (6) extended in the transversal direction (T), and the engagement portion (5) of the second part (3) comprises a hook element (7), which delimits a seat (S) for the engagement pin (6) which seat extends essentially in a transversal direction (T). With the engagement pin (6) placed in the seat (S), a rotational joint is formed with a rotational axis (A) extending in said transversal direction (T) for allowance of the parts (2, 3) to be restrictedly rotatable in relation to each other around the rotational axis (A). The invention also relates to a child carrying device.

### FIELD OF THE INVENTION

The invention relates to a band lock for detachable coupling of bands in accordance with the preamble of claim 1. The invention also relates to a child carrying device, which is provided with such a band lock.

### TECHNICAL BACKGROUND

Such a band lock is known, comprising a first and a second part, which each exhibits engagement portions with engagement elements for mutual locking to each other. The engagement elements are comprised partly by snap projections arranged on resilient locking tongues, partly snap seats, in which the snap projections are arranged to snap in for locking. Detachment takes place by pressing in said projections out of engagement with the snap seats so that pulling apart of the band lock parts may be performed. This type of band lock is often named plug in lock and comprises partly a male part with one or more locking tongues, partly a female part in the form of an enclosing locking cover. In a connected position this device becomes relatively long and stiff.

The known band locks function well but may be improved with regard to the possibility of providing an easily connectable band lock with the possibility for a more flexible and more efficient handling.

This may otherwise be problematic in some situations and in some placements of the band lock and of the band which is to be connected, such as, e.g., at inaccessible positions of the band lock. Also detachment of known band locks may be problematic to provide during some circumstances and in some placements of the band lock.

### OBJECTS AND MOST IMPORTANT FEATURES OF THE INVENTION

It is an object of the present invention to provide a band lock, with which the drawbacks of the prior technique are addressed and at least are alleviated.

These objects are achieved with a band lock of the kind mentioned by way of introduction by that the engagement portion of the first part comprises an essentially transversally extended engagement pin, that the engagement portion of the second part comprises a hook element which delimits an essentially transversally extended seat for the engagement pin, that a resilient locking element is arranged at the seat for acting against and preventing decoupling of an engagement pin inserted therein, and that with the engagement pin placed in the seat the pivoting joint with a transversally extended pivoting axis is formed for allowing the first and the second part to be limitedly pivotable in relation to each other around the pivoting axis. In this connection is intended that from a position, in which the first and the second part lies essentially in line with each other, the respective parts may be angled outwards around the pivoting axis seen from the bearer.

Hereby is achieved that a respective part may be angled an angle, for example to an almost transverse position and possibly even longer, in relation to another respective part. This angular positioning leads to facilitated detachment of the bands in the band coupling portions when the tension is released in these portions in connection with that a changed geometrical relationship between the band and the contact surfaces of the band coupling portions is achieved. Extension of the band is hereby facilitated.

The locking element is suitably arranged on a free end of a tongue formed element. By the lock element a snap effect is also provided and possibly also a snap sound when introducing the engagement pin in the seat, which may serve as an indication on that the engagement pin has taken its place in the seat.

By the seat of the hook element and the engagement pin simultaneously creating partly centre of rotation for the device, partly connecting element, the possibility is achieved for simple band adjustment and a compact embodiment.

Attachment as well as detachment of the first and second parts of the band lock may also be accomplished more easily than what is the case with devices according to the prior art, which requires relatively high degree of guidance for the attachment being possible to achieve in an efficient and safe way. At the device according to the invention attachment may take place with first and second parts in different relative angular positions to each other, which in itself facilitates attachment in inaccessible positions.

It is preferred that the engagement pin is at least partially circularly cylindrical in order to allow mutual smooth movability between the parts. The seat is for corresponding reasons complementary designed to the engagement pin and also at least partially circularly cylindrical.

The hook element is preferably one in said transversal direction extended, bent and for facilitating attachment, an element which tapers off towards a free end.

Each one of the first and the second part comprises preferably a frame of a plastic material, wherein each frame integrally comprises an engagement portion as well as a band coupling portion in order to provide a band lock which is easy to manufacture. The band coupling portion comprises a transversal fixed rod.

At least one of the first and the second parts exhibits preferably side edges with guide lists, which support a movable lock member for locking interaction with said band between the lock member and a transversal fixed rod. This means that an efficient possibility for band tension control is provided and that the low degree of efficiency is avoided, which usually characterizes band locks whose band buckles exhibits fixed transverse booms defining labyrinth-shaped band paths with sharp engagement edges.

As an alternative to having a movable lock member the lock member may be arranged between the guide lists rotatable around a rotational axis being essentially parallel to the transversal direction. The rotatable lock member has an engagement portion with an essentially constant cross section along the rotational axis and with an engagement surface to be in engagement with a band by pressing it towards the transversal fixed rod of the frame, which engagement portion exhibits a distance between the rotational axis and the engagement surface which varies around the rotational axis. With such a rotatable lock member the distance between the fixed rod and the rotatable lock member varies with the rotational position of the rotatable lock member. The rotatable lock member provides for an automatic locking of the band, by arranging the parts of the band lock in line, and an automatic unlocking of the band by arranging the parts of the band lock at an angle to each other.

A rotatable lock member having a varying distance between the rotational axis and the engagement surface may be achieved in many ways. The engagement portion of the rotatable lock member may be essentially symmetrical around a symmetry axis arranged parallel to the rotational axis at a distance from the rotational axis. Preferably the engagement portion is essentially circularly cylindrical around the length axis. Such a form of the engagement surface provides a locking action and a smooth operation of the band lock. In other words the rotational axis may be said to be arranged eccentric in relation to the symmetry axis.

The band lock is preferably arranged with restricting means restricting the rotational movement of the rotatable lock member. The surface of the band lock that is arranged to be in contact with the body of a user essentially defines a first plane. The rotational axis is in a second plane being parallel to the first plane. The engagement portion is restricted by the restricting means to have a major part of its volume between the first plane and the second plane.

The band lock is preferably arranged with means restricting the rotational movement of the lock member. The engagement portion is arranged to have a major part of its volume on a side of the rotational axis facing the side of the band lock on which the resilient lock element is arranged. Such an arrangement of the lock member will lead to an automatic locking of the bands when the parts of the band lock are in line with each other and to automatic release of the locking when the parts of the band lock are angled.

The first part exhibits preferably a transverse list, which is parallel to the engagement pin and arranged at a distance from this that essentially corresponds to the dimension of the hook element, seen between a free end thereof and an outer point on the engagement portion of the second part. This facilitates the attachment procedure.

Suitably the second part is provided with an insertion opening for the engagement pin to the seat directed essentially perpendicularly to said intended longitudinal extension for a band intended for interaction and essentially perpendicularly to said transverse direction.

A child carrying device according to the invention comprising a child harness, upper carrying straps and a waist band, is characterized in that it is provided with a band lock according to the above.

### SHORT DESCRIPTION OF DRAWINGS

Further features and advantages of the invention are evident from the following detailed description with reference to the appended drawings, on which:

FIG. 1 shows a band lock according to the invention with a first and a second part in a connected state in a plan view,

FIG. 2 shows, partly in section, details of the band lock in FIG. 1 with the band lock parts disconnected,

FIG. 3 shows the band lock in FIG. 1 in a side view with the band lock parts in a first mutual position,

FIG. 4 shows the band lock in FIG. 1 in a side view with the band lock parts in a second mutual position, and

FIG. 5 shows a child carrying device with a band lock according to the invention.

FIG. 6 is a cross sectional side view of a band lock according to an alternative embodiment, with the parts of the band lock in line with each other.

FIG. 7 is a cross sectional side view of the band lock of FIG. 6 with the parts of the band lock in an angled position.

FIG. 8 is a top view of the band lock in FIG. 6 and FIG. 7.

### DESCRIPTION OF EMBODIMENTS

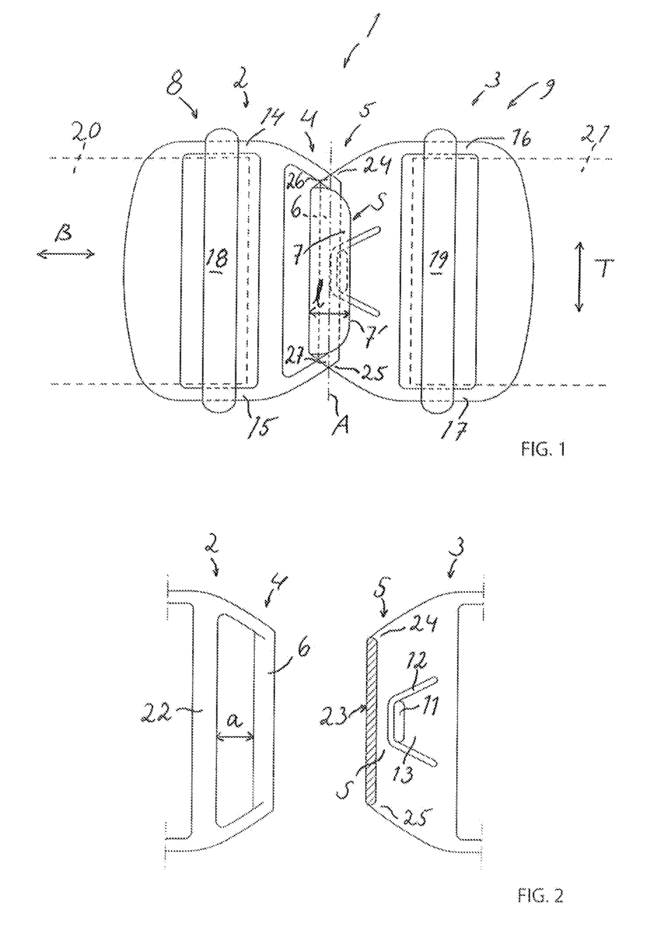

In FIG. 1 a band lock 1 including a first part 2 and a second part 3 is shown in a connected state. Each one of the parts comprises a frame of plastic, which integrally comprises an engagement portion 4 and 5, respectively, at a first end and a band coupling portion 8 and 9, respectively, at a second end.

The engagement portion 4 of the first part 2 comprises an engagement pin 6 (best seen on FIG. 2), which has, seen in a transversal direction (see double arrow denoted T), such an extension that the length of the engagement pin 6 comprises a significant portion of the width, seen in the transversal direction T for the first part 2, for example between 50 and 75% of the width of the first part 2.

The engagement portion 5 of the second part 3 comprises a hook element 7, which is bent around and likewise extends in the transversal direction T for the formation of a seat S being relatively elongated in the transversal direction for engagement with this engagement pin 6, which has the corresponding extension in the transversal direction T as the length of the engagement pin, however, with an extension in the transversal direction T which is somewhat less than the length of the engagement pin 6. The hook element 7 is softly bent around and tapers off in said transversal direction towards a free end 7′. This facilitates coupling of the two parts 2 and 3 in inaccessible positions, especially the insertion of the hook element in the space inside the engagement pin.

The band coupling portions 8 and 9, respectively, of the first and second part comprises in the shown embodiment displaceable lock members 18 and 19, respectively, which are movably arranged on parallel guide lists 14, 15 and 16, 17, respectively arranged on the sides for formation of band tensioning portions.

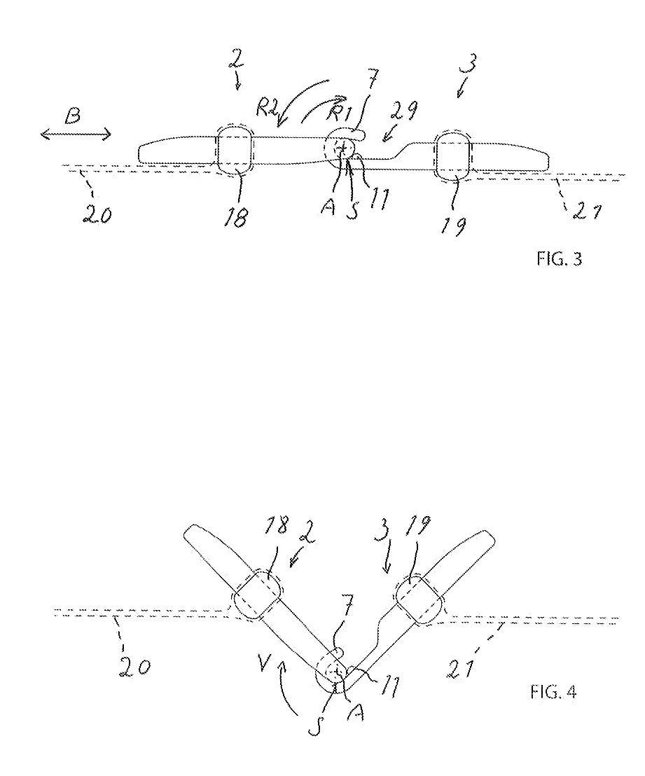

On the frame of the second part stop flanks 24, 25 are arranged outermost in the transversal direction of the engagement portion 5, seen from the seat S, which stop flanks 24 and 25 interacts with portions bent around at the first part 2. These bent around portions 26 and 27 connect bent around to the engagement pin 6 with a mutual distance, which is less than the distance between the stop flanks 24 and 25 so that turning of the first part 2 in relation to the second part 3, from the position shown in FIG. 1, around the engagement pin 6 in a direction R2 (see FIG. 3) is prevented.

From FIG. 1 and FIG. 2 it is also schematically shown with dashed lines band parts 20 and 21, respectively, extended in a band direction B (an intended longitudinal extension B for a band intended for interaction) for interaction with the respective parts 2 and 3.

FIG. 2 shows more clearly the engagement portions 4 and 5, respectively, of the respective parts 2 and 3, wherein the outermost part of the hook element 7 in FIGS. 1 and 2 is cut away for the sake of clarity so that the seat S is shown more clearly.

The engagement portion 5 of the second part 3 exhibits a resilient lock element 11, which is constituted by a rounded list element, arranged on a free end of a tongue-formed element 13, which in turn is laid bare from the rest of the engagement portion 5 by means of a slit 12 that brakes through the material. The resilient lock element 11 is arranged to act against the engagement pin 6 in its applied position in the seat S in order to prevent unintentional decoupling of the parts 2 and 3 from each other. By the lock element a snap effect is also provided and possibly also a snap sound when introducing the engagement pin in the seat, which may serve as an indication on that the engagement pin has taken its place in the seat.

22 denotes a transversal list, which between itself and the engagement pin 6 exhibits a free portion with a dimension a in a direction B (see FIG. 1), which essentially corresponds to a distance 1 between said free end 7′ and an outer point 23 of the engagement portion 5, which facilitates application of the engagement pin in the seat formed by the hook element 7.

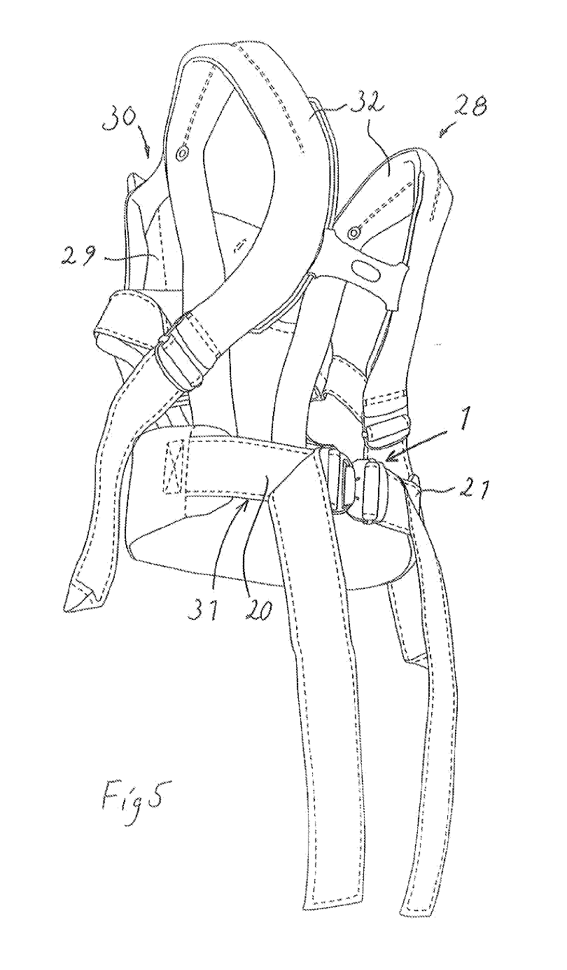

It is also evident, particularly from FIGS. 3 and 4, that the first part 2 is rotatable as around a rotational joint with a rotational axis A extending in the transversal direction through the engagement pin 6 and the seat S in a direction R1, so that the parts 2, 3, may be angled an angle V, for example to a mutual essentially transversal position (and even longer) in relation to each other, which is shown in FIG. 4. Here is from a position, where the first and the second part 2 and 3, respectively, lies essentially in line with each other, according to FIG. 3, each part may be angled outwards around the rotational axis A, seen from the bearer.

Angling in this way for angular positioning of the respective part leads to facilitated loosening of the bands in the band coupling portions 8 and 9, respectively, when the tension is released in these portions in connection with that a changed geometrical relationship between the band and the contact surfaces of the band coupling portions 8 and 9, respectively, is provided. In practice it is here a question about contact surfaces belonging to edge portions of a respective part, that the band abuts.

Elongation of the band is facilitated hereby, which is an advantage in this connection. Also uncoupling of the parts 2 and 3, respectively, from each other from the position shown in the figure may be facilitated through the change in angle.

29 denotes an insertion opening for said seat, which insertion opening is directed outwards, seen from a user, in an angle, which preferably is essentially right, towards the longitudinal extension B for a cooperating band. This direction may also be said to be “essentially radial” at an applied waist band, why insertion of the engagement pin in the insertion opening may be said to occur radially inwards.

The invention may be modified within the frame for the following claims, and as an example the band coupling portions 8 and 9, respectively, may be designed differently, for example so that only one of the parts includes means for adjustability for one of the cooperating bands 20 and 21, respectively, and/or so that the respective band coupling portion lacks a movable lock member. The shown embodiment with a movable lock member on each part is however preferred.

It is also preferred that the band lock according to the invention is manufactured with an integrated frame of a suitable plastic according to the above but it is not excluded that at least some elements of the integral parts are made of metal, for example the engagement pin 6. The engagement pin is suitably circularly cylindrical for the best rotatability and applicability and the seat formed by the hook element 7 is likewise at least partly circularly cylindrical.

It is however, not excluded that these portions have another form even if this is not preferred. The lock member according to the shown embodiment is suitably formed in a plastic material.

The band lock according to the invention is preferably used for a child carrying device carried on the breast side with a waist band, wherein the band lock will be placed on the backside of the user.

In FIG. 5 an example of such a child carrying device 28 is shown, which comprises a harness for carrying a child on the breast side of the body of the bearer. The harness includes further a frontal piece 29, which delimits a carrying pocket 30 for reception of the child that is to be carried. 32 denotes two upper carrying belts, which function as shoulder belts.

At this device a waist band 31 is arranged to transfer a significant part of the load to the hip portion of the user. For this reason the waist band during use should be thoroughly adjusted tightened to abut well against the hips of the user.

This is easily adjusted by tightening/untightening of the relevant band part 20 and 21, respectively, in relation to the respective band coupling portion (8, 9; see FIGS. 1 and 4). The band lock 1 according to the invention is particularly advantageous in this application, as it through its construction facilitates manipulation and in particular adjustment in the band releasing direction for a band lock 1 arranged on the back. Furthermore, it is easy to couple and decouple in the position in question for the application, where it is positioned behind the back of the user and must be handled without the user being able to see what she/he does.

Finally “an intended longitudinal extension B for a band intended for cooperation” means a hypothetical straight direction the band takes when it exits the parts of the band lock, approximately as indicated with the dashed lines in FIGS. 1 and 2 in the areas for the reference numerals 20 and 21.

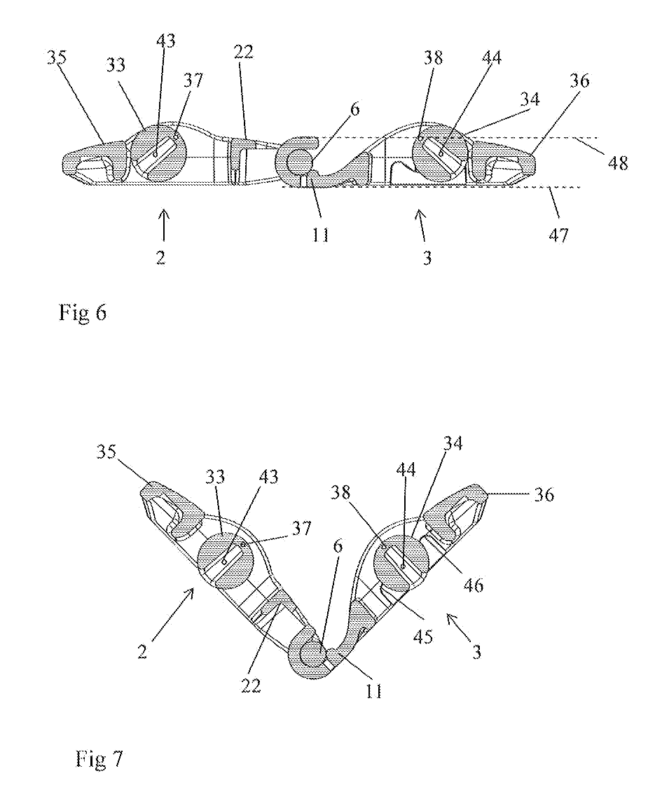

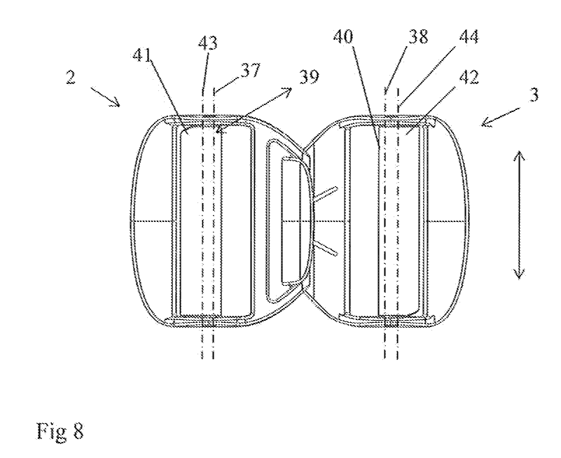

FIG. 6 is a cross sectional side view of a band lock 1 according to an alternative embodiment, with the parts 2, 3, of the band lock 1 in line with each other. FIG. 7 is a cross sectional side view of the band lock 1 of FIG. 6 with the parts of the band lock 1 in an angled position. FIG. 8 is a top view of the band lock 1 in FIG. 6 and FIG. 7. A first rotatable lock member 33, is arranged between the lists 14, 15, of the first part 2, and is rotatable around a first rotational axis 37, which is essentially parallel to the transversal direction. A second rotatable lock member 34, is arranged between the lists 16, 17, of the second part 3, and is rotatable around a second rotational axis 38. The rotatable lock members comprise an engagement portion 39, 40, with an essentially constant cross section along the rotational axis 37, 38, and with an engagement surface 41, 42, to be in engagement with a band (FIGS. 3 and 4). The engagement portions 39, 40, are essentially circularly cylindrical around a symmetry axis 43, 44, which is arranged at a distance from the rotational axis 37, 38. The first part 2 exhibits a transversal fixed rod 35 and the second part 3 exhibits a transversal fixed rod 36. The transversal rods 35, 36, are load bearing members of the parts 2, 3. In FIG. 6 the lock members are shown in the position for locking cooperation with a band (not shown) which is to be squeezed between the rotatable lock member 33, 34, and the corresponding transversal rod 35, 36. The rotatable lock members 33, 34, are automatically rotated to this position when the bands are under tension, which is the case when the bands are part of a harness carried by a user. 11. The band lock also comprises restricting means 45, 46, restricting the rotational movement of the rotatable lock member 33, 34. The surface of the band lock that is arranged to be in contact with the body of a user essentially defines a first plane 47, wherein the rotational axis 37, 38, is in a second plane 48 being parallel to the first plane 47. The engagement portion 39, 40, is restricted by the restricting means to have a major part of its volume between the first plane 47 and the second plane 48.

In FIG. 7 the parts have been angled in relation to each other and the force from the bands have rotated the rotatable lock members 33, 34, to another position in which the band is no longer locked in place.

The invention may be amended in many ways without departing from the spirit and scope of the present invention, which is limited only by the appended claims.

It is not necessary to have the engagement portions 39, 40, circularly cylindrical. It is sufficient for the engagement portion 39, 40, to exhibit a distance between the rotational axis 37, 38, and the engagement surface 41, 42, which varies around the rotational axis 37, 38.

1. Band lock (1) comprising a first (2) and a second (3) part, which each comprises partly engagement portions (4, 5) at respective first ends for mutual detachable coupling with each other, partly band coupling portions (8, 9) at respective second ends for cooperation with a band (20, 21) each, wherein the first (2) and the second (3) part forms a respective transversal direction (T) in right angle to an intended longitudinal extension (B) for and essentially parallel to a transversal extension for a band intended for cooperation, characterized in that
the engagement portion (4) of the first part (2) comprises an engagement pin (6) extending essentially in said transversal direction,
the engagement portion (5) of the second part (3) comprises a hook element (7) which delimits a seat (S) for the engagement pin (6), which seat extends essentially in said transversal direction (T),
a resilient lock element (11) is arranged at the seat (S) for acting against an engagement pin (6) inserted in the seat, and
with the engagement pin (6) placed in the seat (S), a rotational joint is formed, with a rotational axis (A) extending in said transversal direction (T), for allowing the first part (2) and the second part (3) to be limitedly rotatable in relation to each other around the rotational axis (A).

2. Band lock according to claim 1, characterized in that the engagement pin (6) is at least partially circularly cylindrical.

3. Band lock according to claim 2, characterized in that the seat (S) is complementary designed to the engagement pin (6) and likewise at least partially circularly cylindrical.

4. Band lock according to claim 1, characterized in that the hook element (7) is an element which extends in said transversal direction (T), is bent around, and tapers off in said transversal direction (T) towards a free end (7′).

5. Band lock according to claim 1, characterized in that said lock element (11) is arranged on a free end (7′) of a tongue formed element.

6. Band lock according to claim 1, characterized in that each one of the first (2) and the second (3) part comprises a frame of plastic material, wherein each frame integrally comprises an engagement portion (4, 5) as well as a band coupling portion (8, 9).

7. Band lock according to claim 1, characterized in that at least one of the first (2) and the second (3) part exhibits a transversal fixed rod and side edges with guide lists (14, 15, 16, 17), which carries a movable lock member (18, 19) for locking cooperation with said band (20, 21) between the lock member (18, 19) and the fixed rod.

8. Band lock according to claim 1, characterized in that at least one of the first (2) and the second (3) part exhibits a transversal fixed rod (35, 36) and side edges with lists (14, 15, 16, 17), and comprises a rotatable lock member (33, 34), for locking cooperation with said band (20, 21), said rotatable lock member (33, 34) being arranged between the lists (14, 15) rotatable around a rotational axis (37, 38) being essentially parallel to the transversal direction, which rotatable lock member (33, 34) has an engagement portion (39, 40) with an essentially constant cross section along the rotational axis (37, 38) and with an engagement surface (41, 42) to be in engagement with a band (20, 21), which engagement portion (39, 40) exhibits a distance between the rotational axis (37, 38) and the engagement surface (41, 42) which varies around the rotational axis (37, 38).

9. Band lock (1) according to claim 8, characterized in that the engagement portion (39, 40) is essentially symmetrical around a symmetry axis (43, 44) arranged parallel to the rotational axis (37, 38) at a distance from the rotational axis (37, 38).

10. Band lock (1) according to claim 9, characterized in that the engagement portion (39, 40) of the rotatable lock member (33, 34) is essentially circularly cylindrical around the symmetry axis (43, 44).

11. Band lock (1) according to claim 8, characterized in that it is arranged with restricting means (45, 46) restricting the rotational movement of the rotatable lock member (33, 34), wherein the surface of the band lock that is arranged to be in contact with the body of a user essentially defines a first plane (47), wherein the rotational axis (37, 38) is in a second plane (48) being parallel to the first plane (47) and wherein the engagement portion (39, 40) is restricted by the restricting means to have a major part of its volume between the first plane (47) and the second plane.

12. Band lock according to claim 1, characterized in that the first part (2) exhibits a transversal list (22), which is parallel to the engagement pin (6) and situated at a distance (a) from this which essentially corresponds to the dimension of the hook element (7), seen between a free end (7′) thereof and an outer point (23) on the engagement portion (5) of the second part (3).

13. Band lock according to claim 1, characterized in that the second part (5) is provided with an insertion opening (29) for the engagement pin (6) to the seat (S) directed essentially perpendicularly to said intended longitudinal extension (B) for a band intended for cooperation and essentially perpendicularly to said transversal direction (T).

14. Child carrying device including a child harness, upper carrying straps and a waist band, characterized in that it is provided with a band lock according to claim 1.
